(19) United States
(12) Patent Application Publication
(10) Pub. No.: US 2007/0294912 A1
(43) Pub. Date: Dec. 27, 2007

(54) Integrated heater/cooler

(76) Inventors: Ernesto Renzi, Youngstown, NY (US); David Debo, Batavia, NY (US); Francis Ward Demarco, Niagra Falls, NY (US)

Correspondence Address: THE BOC GROUP, INC., 575 MOUNTAIN AVENUE, MURRAY HILL, NJ, 07974-2064, US

(21) Appl. No.: 11/801,147

(22) Filed: May 9, 2007

Related U.S. Application Data
(60) Provisional application No. 60/747,018, filed on May 11, 2006.

(51) Int. Cl. F26B 25/06; F26B 5/06

(52) U.S. Cl. 34/201; 34/284

(57) ABSTRACT

An integrated heater/cooler for heating and cooling of heat transfer fluid in a freeze dryer is provided. This integrated heater/cooler is made up on a housing having a heat exchange fluid outlet to discharge heat exchange fluid; a heat exchanger disposed on one side of the housing having a refrigerant inlet to receive refrigerant, a refrigerant outlet to discharge refrigerant and a heat exchange fluid inlet to receive heat exchange fluid; and a heater disposed on the other side of the housing.

### CROSS REFERENCE TO RELATED APPLICATION

This application claims priority from U.S. Patent Application Ser. No. 60/747,018, filed May 11, 2007.

### FIELD OF THE INVENTION

The present invention provides an apparatus for heating and cooling fluids, and more particularly, the present invention provides an integrated apparatus for heating and cooling heat transfer fluids for use in freeze dryers.

### BACKGROUND OF THE INVENTION

The present invention relates to an integrated heater and cooler that can either transfer heat to or from a fluid. For freeze dryers, particularly those in the industrial pharmaceutical setting, the temperature of the heat transfer fluid, regulates the freeze drying process, and may be controlled by certain heating and cooling mechanisms.

The heat transfer fluid circulates through the heat transfer fluid circuit to cool the articles to a predetermined temperature below the freezing point of the solution while the heat exchange fluid is cooled by a refrigerant circulating through the refrigerant section.

Freeze drier shelves are located within a freeze drying chamber of a freeze drier to support articles such as biological substances or more commonly, vials containing the biological substances to be freeze dried. The shelves are disposed in a vertical stack that may be collapsible in order to stopper the vials.

The shelves also serve to transfer heat between a heat exchange fluid such as alcohol, glycol, mineral oil, etc. and the articles to be freeze dried. During the freeze drying process, liquid present within the articles is frozen. After freezing, the articles are subjected to subatmospheric pressures that are low enough to enable the moisture to sublime into a vapor. To this end, heat exchange fluid circulating within the freeze drier shelves is first cooled by an external refrigeration circuit in order to cause heat to transfer from the articles to the heat exchange fluid and thereby cause the freezing of the liquid contained within the articles. During sublimation, the heat exchange fluid is heated by an external heater in order to provide energy for the sublimation process.

Since the freeze drying process occurs in a low pressure environment, heat transfer between the articles and the heat exchange fluid occurs principally by conduction.

In addition to the foregoing, the energy required to effect the cooling is also lost through heat leakage occurring during the cooling of the heat exchange fluid. In the refrigeration circuit used in cooling the heat exchange fluid, an external heat exchanger is provided to transfer heat from the heat exchange fluid to a recoverable refrigerant such as FREON. Inevitably, there are thermal losses in the heat exchanger and the piping involved in conducting the cooled heat exchange fluid back into the freeze drying chamber. As may be appreciated, such heat leakage must be compensated for by increasing the amount of refrigeration provided by the refrigeration circuit and thus, the energy required to provide the refrigeration. In addition, the volume of oil required to fill the associated piping results in additional system cost as the cost of the heat exchange fluid may be considerable.

The current method of heating and cooling the heat exchange fluid is through the use of separate heat exchangers for heating and cooling duty. However, there are problems associated with the use of separate heat exchangers for heating and cooling the heat exchange fluid. The layout of the heat exchangers may be inefficient, partly by the need for piping between heat exchangers and the associated risk of piping and filling leaks. The use of a plurality of heat exchangers will require additional pressure drop. These and other factors all contribute to the use of using separate heat exchangers for heating and cooling duty.

As will be discussed, the present invention provides an integrated heater and cooler designed to minimize the drawbacks of the current use of multiple heat exchangers for heating and cooling duty, particularly in the freeze dryer. The combined heater/cooler minimizes the loss heat leakage during the cooling of the heat exchange fluid.

### SUMMARY OF THE INVENTION

The present invention provides an integrated heater/cooler for heating and cooling of heat transfer fluid in a freeze dryer that comprises a housing having a heat exchange fluid outlet to discharge heat exchange fluid; a heat exchanger disposed on one side of the housing having a refrigerant inlet to receive refrigerant, a refrigerant outlet to discharge refrigerant and a heat exchange fluid inlet to receive heat exchange fluid; and a heater disposed on the other side of the housing.

The housing is cylindrical. The heat exchanger is a helical wound heat exchanger. In an embodiment, the heat exchanger is a helical wound liquid nitrogen heat exchanger. The heater is an electric resistance heater. The heat transfer fluid may be any number of commercially available oils suitable for the application, and the refrigerant may be liquid nitrogen, liquid oxygen, and liquid carbon dioxide.

### BRIEF DESCRIPTION OF THE DRAWINGS

While the specification concludes with claims distinctly pointing the subject matter that Applicant regards as his invention, it is believed that the invention would be better understood when taken in connection with the accompanying drawings in which:

FIG. 1 is a perspective view of a integrated heater/cooler for use in freeze drying applications in accordance with the present invention; and

FIG. 2 is a top plan view of the integrated heater/cooler of FIG. 1.

### DETAILED DESCRIPTION OF PREFERRED EMBODIMENTS

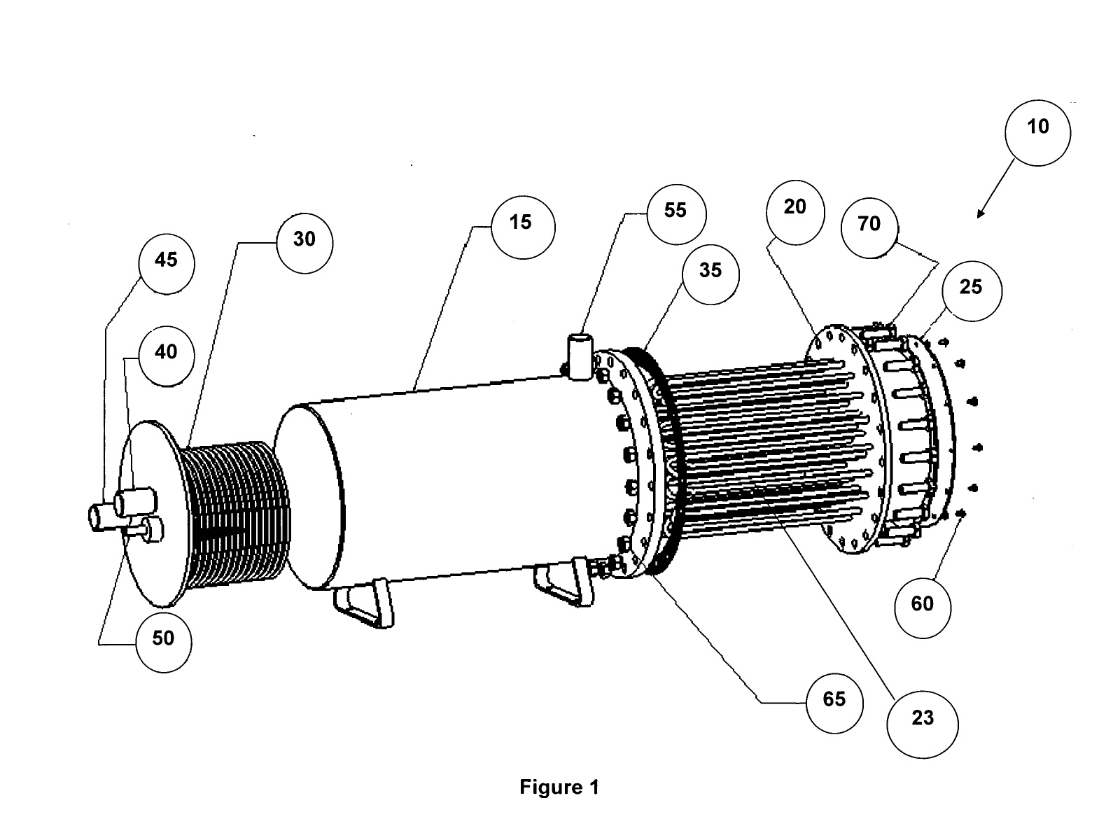

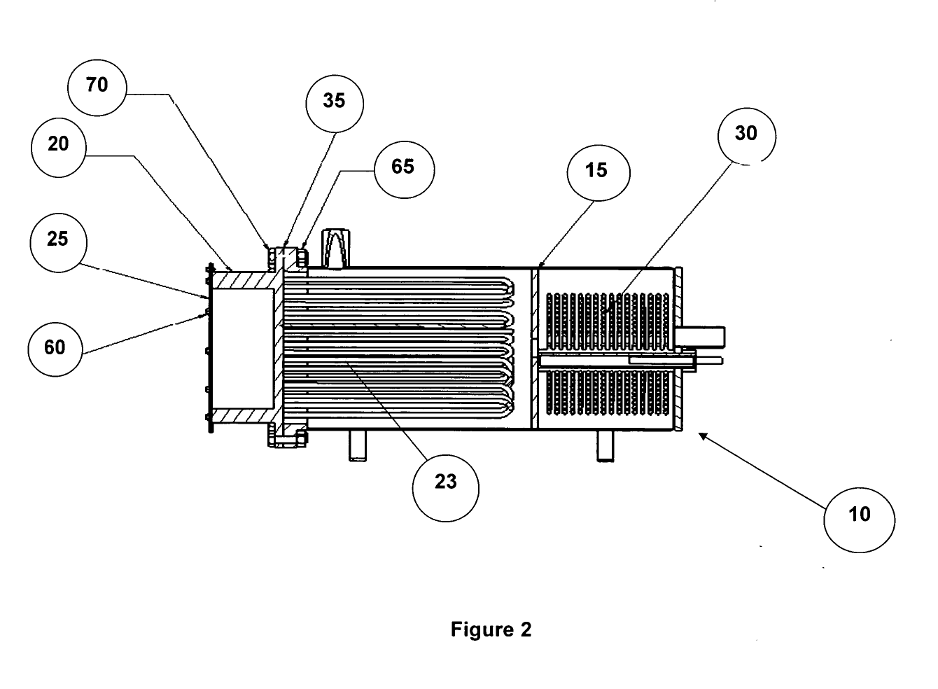

With reference to FIGS. 1 and 2, an integrated heater/cooler 10 in accordance with the present invention is illustrated. A heater/cooler housing 15 is provided to enclose the integrated heater and cooling units. Typically, the housing may be made of steel, stainless steel or cast iron. The temperature of the housing is generally resistant to in the temperature of from about −320° F. to about 350° F., preferably between from about −112° F. to about 212° F. In one embodiment, the housing 15 is cylindrical, and it may contain a stand or similar mechanism to prevent it from moving about. Alternatively, materials can be placed or jammed against the housing 15 to ensure stability of the housing and prevent it from rolling. Housing of other shapes, i.e., rectangular box shape may also be appropriate.

On one end of the heater/cooler housing 15 is fitted an electric resistant heater 20. As in a conventional heater, heating coils 23 project from the electric resistant heater 20. The heater housing electrical cover 25 on the opposite end of the heater 20 from the heating coils 23 faces outwardly from the housing 15 when the heater 20 is in place. The heater is commercially available from Watlow Electric Manufacturing Company, St. Louis, Mo. as WATROD Heaters. At least one electric heater housing gasket 35 is positioned and held in place between the electric resistance heater 20 and the heater/cooler housing 15 to ensure a tight seal between the heater coils 23 and the housing, such that heat is maintained inside the electric resistant heater 20, and not lost to the ambient. Heater housing bolts 70 fastens the electric resistance heater 20 onto the heat housing gasket 35 and the heater/cooler housing. Heater electric cover bolts 60 and heater housing nuts 65 secure the integrated heater/cooler 20 to the heater/cooler housing 15.

On the other end of the heater/cooler housing 15 is fifted a helical liquid nitrogen heat exchanger 30. The heat exchanger is commercially available from Graham Corporation, Batavia, N.Y. as HELIFLOW Heat Exchangers. Liquid nitrogen inlet 50 and liquid nitrogen outlet 45 enables coolants, in this case liquid nitrogen, to fill and flow throughout the baffles or coils of the heat exchanger 30, while cooling down the heat transfer fluid, such as heat exchange fluid. The heat exchange fluid supports the articles to be freeze dried and is designed to receive and circulate a cooled heat exchange fluid so that heat is transferred from the article being supported to the heat exchange fluid. Heat exchange fluid is commercially available from the Dow Chemical Co., Midland, Mich. as Syltherm XLT. Heat transfer fluids other than silicone based fluid may include flourinated HFPE. Although liquid nitrogen is used as a refrigerant, other refrigerants known to those skilled in the art can also be used. The refrigerants may include liquid nitrogen, liquid oxygen, liquid carbon dioxide or any other commercially available refrigerants. Heat exchange fluid enters the integrated heater/cooler housing 15 through the heat exchange fluid inlet 40 in the helical heat exchanger 30, flowing through the heater/cooler housing 15 and discharging therefrom through heat exchange fluid outlet 55 on the heat exchange housing 65. Adjustment to the temperature and properties at which the coolant flows through the heat exchanger 30 depends on the type of coolants and rate at which the coolant flows through the heat exchanger coils. In one embodiment, liquid nitrogen is used as the coolant. Other embodiments may use other coolants such as liquid carbon dioxide, liquid helium, or other coolants known to those skilled in the art.

The heater/cooler of the present invention is positioned between the fluid circulation pumps and the product shelves, and is physically placed adjacent to the chamber vessel in such a way as to minimize piping.

The heater/cooler of the present invention enables accurate control of the heating/cooling process during the freeze drying process. The housing and internal baffles or coils direct the heat transfer fluid, i.e., the heat exchange fluid, through the heat exchange path in a controlled manner that enables meeting the temperature performance requirement.

Additionally, the integrated heater/cooler provides for an efficient use of space in the freeze drying layout. The integrated heater/cooler operates in a significantly reduced space, thus reducing the number and distance of lines for carrying the heat transfer fluid and as well as the heat exchange fluid. As a result, there is reduced pressure drop and thermal loss during the flow of the heat transfer fluid through the integrated heater/cooler as compared to the conventional system. Significant cost savings is achieved through reduced use of the heat transfer fluid and the heat exchange fluid.

Significant improvement can also be achieved over the present integrated heater/cooler due to minimizing the possibility of leaks. Because less piping is required in the integrated heater/cooler, the chance of leaks is reduced.

As in a conventional heater, heating coils 23 project from the electric resistant heater 20. The heater housing electrical cover 25 on the opposite end of the heater 20 from the heating coils 23 faces outwardly from the housing 10 when the heater 20 is in place. At least one electric heater housing gasket 35 is positioned and held in place between the electric resistance heater 20 and the heater/cooler housing 15 to ensure a tight seal between the heater coils 23 and the housing, such that heat is maintained inside the electric resistant heater 20, and not lost to the ambient. Heater housing bolts 70 fastens the electric resistance heater 20 onto the heat housing gasket 35 and the heater/cooler housing.

While a preferred embodiment has been shown and described in detail, it would be appreciated by those skilled in the art that numerous additions, omissions and changes may be made without departing from the spirit and scope of the invention.

What is claimed is:

1. An integrated heater/cooler for heating and cooling of heat transfer fluid in a freeze dryer comprising
a housing having a heat exchange fluid outlet to discharge heat exchange fluid;
a heat exchanger disposed on one side of the housing having a refrigerant inlet to receive refrigerant, a refrigerant outlet to discharge refrigerant and a heat exchange fluid inlet to receive heat exchange fluid; and
a heater disposed on the other side of the housing.

2. The integrated heater/cooler of claim 1 wherein the housing is cylindrical.

3. The integrated heater/cooler of claim 1 wherein the heat exchanger is a helical wound heat exchanger.

4. The integrated heater/cooler of claim 1 wherein the heat exchanger is a helical wound liquid nitrogen heat exchanger.

5. The integrated heater/cooler of claim 1 wherein the heater is an electric resistance heater.

6. The integrated heater/cooler of claim 1 wherein the heat transfer fluid is heat exchange fluid.

7. The integrated heater/cooler of claim 1 wherein the refrigerant is selected from the group consisting of liquid nitrogen, liquid oxygen, liquid carbon dioxide, liquid helium and FREON.

8. The integrated heater/cooler of claim 1 wherein the refrigerant is liquid nitrogen.
